(19) United States
(12) Patent Application Publication
(10) Pub. No.: US 2016/0039208 A1
(43) Pub. Date: Feb. 11, 2016

(54) MIXING ONE OR MORE PRINTING MATERIALS WITH DIFFERENT REFRACTIVE INDICES IN ONE PRINT JOB

(71) Applicant: LUXEXCEL HOLDING B.V., Kruiningen (NL)

(72) Inventors: Richard Van De Vrie, Wolphaartsdijk (NL); Joris Biskop, Vlissingen (NL)

(21) Appl. No.: 14/775,086

(22) PCT Filed: Mar. 11, 2014
(86) PCT No.: PCT/EP2014/054694

§ 371 Date: Sep. 11, 2015

(30) Foreign Application Priority Data
Mar. 21, 2013 (EP) 13160499.3

(51) Int. Cl. B41J 2/175; B41J 3/407

(52) U.S. Cl. CPC B41J 2/175; B41J 3/407

(57) ABSTRACT

The present invention relates a print head (1) for printing an optical structure (2) having a specific refractive index on a substrate (3), the print head comprising at least one ejection device (4), a first ink tank (5a), a second ink tank (5b) and a curing device (6), wherein the ejection device is configured for ejecting at least one droplet (7aa, 7b) of at least one printing ink towards the substrate, wherein the first ink tank comprises a first printing ink, wherein the second ink tank comprises a second printing ink, wherein the first printing ink comprises a first refractive index being different from the specific refractive index, wherein the second printing ink comprises a second refractive index being different from the specific refractive index and being different from the first refractive index, wherein the print head is configured such that the first printing ink and the second printing ink are mixed in such a ratio yielding a mixed ink (7c) having a refractive index equal to the desired specific refractive index.

### BACKGROUND

The present invention relates to a print head and a method for printing an optical structure having a specific refractive index on a substrate.

It is well known from the applicant's prior art document WO 2010/091 888 A1 to print three-dimensional structures, in particular optical structures, by means of droplet-on-demand inkjet technologies. A movable print head is used for depositing single droplets of a transparent printing ink at certain positions onto a substrate. The print head is provided with ultraviolet (UV) light sources for curing the deposited droplets by UV irradiation. A three-dimensional optical element is built up by a plurality of deposited and cured droplets arranged at least partially one above the other and side to side.

Yet, the refractive index of the optical element necessarily matches the refractive index of the printing ink used for the print job. Different refractive indices can only be achieved by printing inserts or layers with another printing ink having another refractive index in a subsequent print job. Therefore, according to the prior art, in order to print a homogeneous three dimensional structure having a specific refractive index, a printing ink having the specific refractive index has to be created, which is difficult and cost intensive.

### SUMMARY

It is an object of the present invention to provide a print head and a method for printing an optical structure having a specific refractive index on a substrate using at least one printing ink having a different refractive index than the one of the optical structure.

The object of the present invention is achieved with a print head for printing an optical structure having a specific refractive index on a substrate, the print head comprising at least one ejection device, a first ink tank, a second ink tank and a curing device, wherein the ejection device is configured for ejecting at least one droplet of at least one printing ink towards the substrate, wherein the first ink tank comprises a first printing ink, wherein the second ink tank comprises a second printing ink, wherein the first printing ink comprises a first refractive index being different from the specific refractive index, wherein the second printing ink comprises a second refractive index being different from the specific refractive index and being different from the first refractive index, wherein the print head is configured such that the first printing ink and the second printing ink are mixed in such a ratio yielding a mixed ink having a refractive index equal to the desired specific refractive index.

It is herewith advantageously possible to built up an optical structure having a specific refractive index by mixing at least two different inks with different refractive indices. Thus, any optical element having any desired refractive index can be printed using droplet-on-demand inkjet technologies requiring only a limited number of printing inks with different refractive indices. Thus, the costs of creating printing inks with specific refractive indices for each optical structure can be avoided. Furthermore, it is advantageously possible to print a complex optical element having multiple zones or parts with at least partly different refractive indices and/or any desired shape. As only few printing inks need to be produced and/or stored and/or used, those few printing inks can be produced in large quantities and thus, the production costs can be lowered. As a further advantage, the print head according to the present invention can be used in most printers known in the prior art, such that upgrade kits comprising the print head according to the present invention are producible, wherein a printer is upgradeable with such an upgrade kit to provide the functionality of printing an optical structure having a specific refractive index. As still a further advantage, optical elements can be produced using a print head according to the present invention and/or a method according to the present invention with low costs and substantially no design limitations, in particular concerning its optical properties and/or its shape and/or its color. Thereby, new products are conceivable making use of the new optical elements such as particularly flat cameras, lighting means providing a particular light shape and/or low-cost, individually designed glasses or spectacles respectively. Optical structures are elements that transmit and/or reflect light at least partially and which act upon the light being transmitted and/or being reflected, thereby altering the optical path of the light. Such optical structures are for example lenses, glasses, spectacles, prisms or mirrors. The optical properties of such optical structures are usually different for different wavelengths of incoming electromagnetic radiation. In the context of the present application, in particular refractive optical structures such as lenses or prisms or the like are meant by optical structures, and in particular the visible regime of electromagnetic radiation is meant by light. The optical structure preferably has one specific refractive index. More preferably, the optical structure consists of multiple parts, wherein at least two parts have a different specific refractive index. Preferably, the optical structure is a three-dimensional structure. More preferably, the optical structure is a substantially two-dimensional structure, in particular an optical foil. Preferably, the print head is a piezoelectric print head. Alternatively, the print head is a thermal or electrostatic or acoustic print head. Preferably, the print head is movable above the substrate in at least two dimensions. More preferably, the print head is rotatable and/or tiltable. It is herewith advantageously possible to built up even complex optical structures as the print head can substantially freely be moved around in the space above the substrate. Preferably, the substrate is planar. More preferably, the substrate is transparent at least for the radiation used for curing. It is herewith advantageously possible to allow for a back exposure of the optical structure, which means that the curing radiation is reflected from underneath the substrate and thus reaches parts of the optical structure that cannot be reached by the radiation from above, e.g. because those parts are already covered with droplets of printing ink. Preferably, the ejection device comprises a nozzle through which droplets of the printing ink are ejected towards the substrate. The printing ink is stored in an ink tank which is connected to the ejection device. Preferably, the ink tank is integrated into the print head. More preferably, the ink tank is stored outside the print head and is connected to the print head, in particular by flexible tubes and/or ducts.

According to a preferred embodiment of the present invention, the print head comprises separate ejection devices for each printing ink and each ejection device is connected at least to an ink tank comprising the corresponding printing ink. It is herewith advantageously possible to avoid contamination of a droplet of a certain printing ink with particles of another printing ink ejected by the same ejection device. Thus, the mixing ratio of the mixing ink and/or the refractive index of the mixed ink can be controlled more precisely. Furthermore, it is advantageously possible to provide additional ejection devices e.g. for colored inks, thereby allowing for an easy, cheap and process efficient way of producing even colored optical structures and/or devices comprising optical structures.

According to another preferred embodiment of the present invention, the print head is configured such that at least one droplet of the first printing ink and at least one droplet of the second printing ink are mixed in-flight, in particular after being ejected and before being deposited on the substrate. Preferably, the at least one droplet of the first printing ink and the at least one droplet of the second printing ink are ejected by separate ejection devices. It is herewith advantageously possible to provide a fast mixing method without the need for an additional mixing chamber or complex mixing arrangements. More preferably, the at least one droplet of the first printing ink and the at least one droplet of the second printing ink are ejected by the same ejection device. Even more preferably, the at least one droplet of the first printing ink and the at least one droplet of the second printing ink are ejected simultaneously. By simultaneously ejecting the droplets of the first printing ink and second printing ink, the printing speed is considerably increased. In a further preferred embodiment of the present invention, the at least one droplet of the first printing ink and the at least one droplet of the second printing ink are ejected one after another, in particular by the same ejection device. In this case, the ejection speeds of the at least one droplet of the first printing ink and the at least one droplet of the second printing ink that are ejected are different in order to allow for an in-flight mixing. It is thereby advantageously possible to use only one ejection device and yet provide for an in-flight mixing functionality, thus eliminating the costs for separate ejection devices as well as allowing for a simpler maintenance.

According to another preferred embodiment of the present invention, the print head is configured such that at least one droplet of the first printing ink and at least one droplet of the second printing ink are mixed in a mixing chamber of the print head, in particular before being ejected. Preferably, the mixing chamber is a separate volume, in particular comparable to an ink tank. More preferably, the mixing chamber is integrated in the print head, in particular in the ejection device, at a position where the first printing ink and the second printing ink meet before being ejected. Even more preferably, the first printing ink and the second printing ink are mixed droplet-wise or continuously. It is herewith advantageously possible to provide storage for pre-mixed ink. Thus, the printing itself can be performed at higher speeds and no minimum distance, as required for in-flight mixing, has to be maintained. Furthermore, the mixed ink in the mixing chamber is controllable, e.g. heatable, which allows for manipulating its physical properties, e.g. it is possible to control its viscosity by heating and/or cooling.

According to another preferred embodiment of the present invention, the print head is configured such that at least one droplet of the first printing ink is deposited on the substrate and at least one droplet of the second printing ink is deposited substantially at the same position of the substrate, in particular before being cured, in particular before being totally cured, yielding a droplet of mixed ink. Preferably the at least one droplet of the first printing ink and the at least one droplet of the second printing ink are deposited one after another. More preferably, the at least one droplet of the first printing ink and the at least one droplet of the second printing ink are deposited simultaneously. It is herewith advantageously possible to provide a fast mixing process while employing a simply constructed print head having only one ejection device. Furthermore, by varying the curing speed and/or strength, different degrees of mixing can be achieved, which is desirable for structures comprising zones and/or inlets having a continuously varying refractive index.

According to another preferred embodiment of the present invention, the curing device is configured for curing at least one droplet of the mixed ink that is deposited on the substrate, wherein the curing device comprises at least an ultraviolet light source, in particular an ultraviolet light emitting diode. Alternatively or additionally, the curing device comprises an infrared (IR) light source. Preferably, the curing device comprises two light sources, in particular with different wavelength ranges. It is herewith advantageously possible to cure the deposited droplets of mixed ink even faster, thus allowing for a faster print job.

According to another preferred embodiment of the present invention, the size of a droplet of the first printing ink and/or second printing ink and/or mixed ink is different from the size of another droplet of the first printing ink and/or second printing ink and/or mixed ink. Preferably, the droplet size is adjustable according to the mixing ratio. It is herewith advantageously possible to vary the droplet size according to the current requirements. Thus, e.g. larger droplets are used for larger and/or less complexly shaped optical structures, while smaller drops are used for smaller and/or more complex optical structures. Thereby, the printing speed is advantageously adjustable according to the complexity of the optical structure.

According to another preferred embodiment of the present invention, the first printing ink and/or second printing ink is substantially transparent, wherein the print head is further configured for ejecting at least one droplet of a third printing ink, wherein the print head comprises at least a third ink tank, wherein the third ink tank comprises the third printing ink, wherein the third printing ink is a colored printing ink and wherein the mixed ink comprises at least one droplet of the third printing ink. Preferably, the third printing ink has a refractive index that is different from the specific refractive index and/or the first refractive index and/or the second refractive index. More preferably, colored printing inks in all primary colors are provided, in particular according to an additive color method such as the RGB (red, green, blue) color model or according to an subtractive color method such as the CMYK (cyan, magenta, yellow, key) color model. It is herewith advantageously possible not only to print transparent optical structures such as commonly known lenses or the like, but also to print colored optical structures, such as e.g. prescription sun glasses. Furthermore, it is advantageously possible to print the instruments and/or structures that comprise the optical structure as well. Therefore, the method is suitable for creating entire products in a low-cost, fast and easy way.

Another subject of the present invention is a method for printing an optical structure having a specific refractive index on a substrate, using a print head ejecting at least one droplet of at least one printing ink, and comprising the steps of determining the required mixing ratio of at least a first printing ink having a first refractive index and at least a second printing ink having a second refractive index such that the resulting mixed ink has a refractive index that equals the desired specific refractive index, wherein the first refractive index differs from the specific refractive index and wherein the second refractive index differs from the specific refractive index and from the first refractive index, mixing the first printing ink and the second printing ink according to the determined ratio, curing at least one droplet of the mixed ink that is deposited on the substrate. It is herewith advantageously possible to provide a method for printing an optical structure having a specific refractive index using only a limited number of printing inks having different refractive indices. Thus, the method provides a low-cost and fast process for building up arbitrarily configured optical structures. Preferably, the first printing ink and the second printing ink are mixed droplet-wise, wherein the droplet size is variable. More preferably, the first printing ink and the second printing ink are mixed continuously, i.e. in a continuous flow (but ejected droplet-wise). A person skilled in the art acknowledges that a continuous mixing is only possible when the step of mixing the first printing ink and the second printing ink is performed in the print head. Preferably, the step of determining the mixing ratio is performed by a control means controlling the print head.

According to another preferred embodiment of the present invention, the method further comprises the steps of ejecting at least one droplet of the first printing ink and at least one droplet of the second printing ink, and/or ejecting at least one droplet of the mixed ink, and/or the curing of the deposited droplets is performed by an ultraviolet light source, in particular an ultraviolet light emitting diode. Alternatively or additionally, the curing is performed using an infrared (IR) light source. Preferably, the curing is performed by at least two light sources, in particular UV light emitting diodes, in particular simultaneously or subsequently.

According to another preferred embodiment of the present invention, multiple droplets of the first printing ink and/or second printing ink and/or the mixed ink are deposited at least partially on top of each other and/or side by side. Thus, in contrast to common methods of Rapid Prototyping, the optical structure is not built up layer by layer, but rather droplet by droplet. Preferably, the droplets are firstly arranged side by side and secondly on top of each other. More preferably, the droplets overlap at least partially when deposited. It is herewith advantageously possible to built up homogeneous optical structures droplet-wise. Especially by depositing the droplets in a way that they at least partially overlap, a structurally sound, i.e. rigid, structure can be built up.

According to another preferred embodiment of the present invention, at least one droplet of the first printing ink and at least one droplet of the second printing ink are mixed in-flight, in particular after being ejected and before being deposited. Preferably, the at least one droplet of the first printing ink and the at least one droplet of the second printing ink are ejected simultaneously. More preferably, the at least one droplet of the first printing ink and the at least one droplet of the second printing ink are ejected one after another. In this case, the at least one droplet of the first printing ink and the at least one droplet of the second printing ink are ejected at different speeds in order to allow for an in-flight mixing. It is thereby advantageously possible to use only one ejection device and yet provide for an in-flight mixing functionality, thus eliminating the costs for separate ejection devices as well as allowing for a simpler maintenance.

According to another preferred embodiment of the present invention, at least one droplet of the first printing ink and at least one droplet of the second printing ink are mixed in a mixing chamber of the print head, in particular before being ejected. Preferably, the first printing ink and the second printing ink are mixed droplet-wise or continuously. It is herewith advantageously possible that the print job can be performed at higher speeds and no minimum distance, as required for in-flight mixing, has to be maintained. Furthermore, the mixed ink in the mixing chamber is controllable, e.g. heatable, which allows for manipulating its physical properties, e.g. it is possible to control its viscosity by heating and/or cooling.

According to another preferred embodiment of the present invention, at least one droplet of the first printing ink is deposited on the substrate and at least one droplet of the second printing ink is deposited substantially at the same position of the substrate, in particular before being cured, in particular before being totally cured, yielding a droplet of mixed ink. Preferably the at least one droplet of the first printing ink and the at least one droplet of the second printing ink are deposited one after another. More preferably, the at least one droplet of the first printing ink and the at least one droplet of the second printing ink are deposited simultaneously. It is herewith advantageously possible to provide a fast mixing process while employing a simply constructed print head having only one ejection device. Furthermore, by varying the curing speed and/or strength, different degrees of mixing can be achieved, which is desirable for structures comprising zones and/or inlets having a continuously varying refractive index.

According to another preferred embodiment of the present invention, the droplets of the first printing ink and/or second printing ink and/or mixed ink are ejected in different sizes. Preferably, the droplet size is adjusted according to the mixing ratio. It is herewith advantageously possible to vary the droplet size according to the current requirements. Thus, e.g. larger droplets are used for larger and/or less complexly shaped optical structures, while smaller drops are used for smaller and/or more complex optical structures. Thereby, the printing speed is advantageously adjustable according to the complexity of the optical structure.

These and other characteristics, features and advantages of the present invention will become apparent from the following detailed description, taken in conjunction with the accompanying drawing, which illustrates, by way of example, the principles of the invention. The description is given for the sake of example only, without limiting the scope of the invention. The reference figures quoted below refer to the attached drawings.

### BRIEF DESCRIPTION OF THE DRAWINGS

FIG. 1 illustrates schematically a method for printing a three-dimensional optical structure having a specific refractive index and a print head according to a first exemplary embodiment of the present invention.

FIG. 2 illustrates schematically a method for printing a three-dimensional optical structure having a specific refractive index and a print head according to a second exemplary embodiment of the present invention.

FIG. 3 illustrates schematically a method for printing a three-dimensional optical structure and a print head according to a third exemplary embodiment of the present invention.

### DETAILED DESCRIPTION

The present invention will be described with respect to particular embodiments and with reference to certain drawings but the invention is not limited thereto but only by the claims. The drawings describe the invention only schematically and non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated here-in.

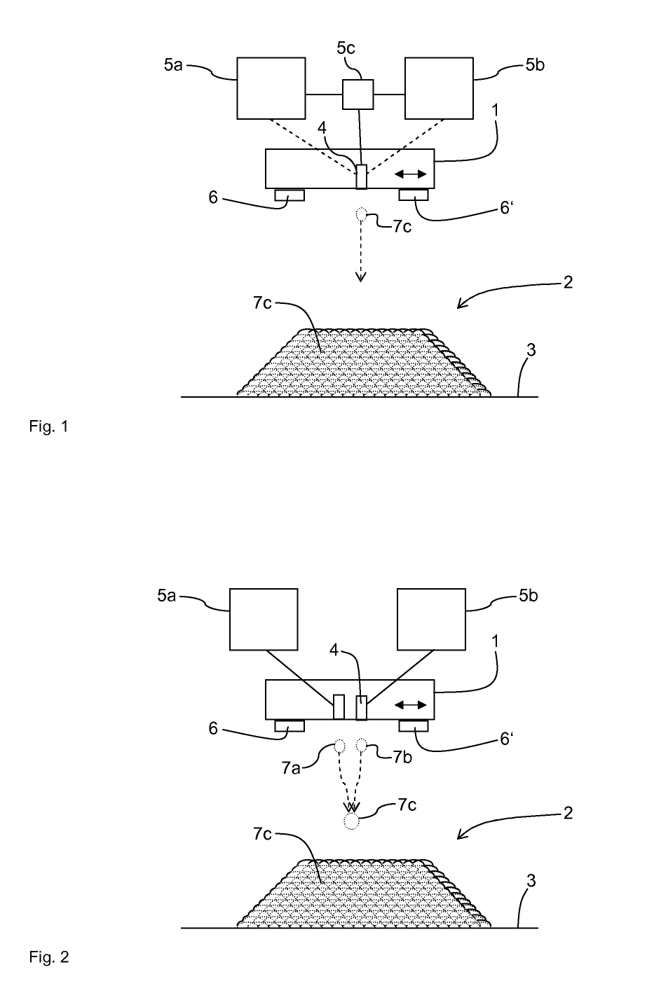

In FIG. 1, a method for printing a three-dimensional optical structure 2 having a specific refractive index nₒ and a print head 1 according to a first exemplary embodiment of the present invention are shown schematically. The print head 1 is integrated in an inkjet printer (not shown) and is movable in at least two dimensions above the substrate 3. This is indicated by the double-arrow in the print head 1. Optionally, the print head 1 is also movable in a third dimension, e.g. up and down in the drawing plane, i.e. in the direction of the substrate 3 and in the opposite direction, and/or tiltable around at least one rotational axis, in particular a rotational axis running through the print head 1. The print head 1 comprises an ejection device 4, which is connected to a mixing chamber 5c. The ejection device is e.g. a piezoelectric ejection device. The mixing chamber 5c is connected to at least a first ink tank 5a and a second ink tank 5b. Preferably, the first ink tank 5a and the second ink tank 5b are directly connected to the ejection device 4 as well, as indicated by the dashed lines. Thus, the ejection device 4 is configured to eject at least one droplet of a mixed ink 7c stored in the mixing chamber 5c. Preferably, the ejection device is also configured for ejecting at least one droplet of a first printing ink 7a and/or a second printing ink 7b. The first ink tank 5a comprises the first printing ink 7a and the second ink tank 5b comprises the second printing ink 7b. The first printing ink 7a has a first refractive index nₐ and the second printing ink 7b has a second refractive index n_{b}, wherein the first refractive index nₐ is different from the second refractive index n_{b}. The first printing ink 7a and the second printing ink 7b are transparent. The print head 1 further comprises at least one curing device 6. In this exemplary embodiment, the print head 1 comprises two curing devices 6, 6′. Those curing devices 6, 6′ are e.g. UV light emitting diodes. The curing device 6 differs from the further curing device 6′ in that the wavelength of the emitted UV radiation is different. Thus, the curing effect of the UV curable printing inks 7 is enhanced. A three dimensional optical structure 2 is to be printed on the substrate 3, wherein the optical structure 2 has to have a specific refractive index nₒ being different from the first refractive index nₐ and being different from the second refractive index n_{b}. Therefore, the print head 1, or in particular a control means (not shown) controlling the print head 1, determines a mixing ratio of the first printing ink 7a and the second printing ink 7b such that the resulting mixed ink 7c has a refractive index n_{c} equal to the specific refractive index nₒ (of the optical structure). Subsequently, the mixed ink 7c is created by mixing the first printing ink 7a and the second printing ink 7b according to the determined mixing ratio. The mixing is either performed droplet-wise or continuously. When mixing the first printing ink 7a and the second printing ink 7b droplet-wise, the droplet size is variable according to another embodiment, thus allowing for a continuous range of possible refractive indices. Then, at least one droplet of the mixed ink 7c is ejected by the ejection device 4 towards the substrate 3. Multiple droplets of the mixed ink 7c are deposited partially one above another and side to side. The deposited droplets of the mixed ink 7c are cured by the curing devices 6, 6′, thus creating the optical structure 2 having the specific refractive index nₒ. It is also conceivable that the print head 1 comprises multiple ejection devices 4, one for each printing ink 7. For example, the print head 1 comprises one ejection device 4 connected to the first ink tank 5a for ejecting at least one droplet of the first printing ink 7a, another ejection device 4 connected to the second ink tank 7b for ejecting at least one droplet of the second printing ink 7b and a further ejection device 4 connected to the mixing chamber 5c for ejecting at least one droplet of the mixed ink 7c.

In FIG. 2, a method for printing a three-dimensional optical structure 2 having a specific refractive index nₒ and a print head 1 according to a second exemplary embodiment of the present invention are shown schematically. The second exemplary embodiment corresponds substantially to the first exemplary embodiment, with the difference that according to the second exemplary embodiment, there is no mixing chamber 5c. Instead, the first printing ink 7a and the second printing ink 7b are mixed in-flight. As illustrated, the print head 1 comprises two ejection devices 4, wherein one ejection device 4 is connected to the first ink tank 5a and is configured for ejecting at least one droplet of the first printing ink 7a, wherein the other ejection device 4 is connected to the second ink tank 5b and is configured for ejecting at least one droplet of the second printing ink 7b. As in the first exemplary embodiment, the mixing ratio yielding a mixed ink 7c with a refractive index n_{c}, equal to the desired specific refractive index nₒ, is determined. Subsequently, at least one droplet of the first printing ink 7a is ejected and at least one droplet of the second printing ink 7b is ejected. The ejection devices 4 are configured such that the at least one droplet of the first printing ink 7a and the at least one droplet of the second printing ink 7b meet after being ejected and before being deposited on the substrate 3 and mix, yielding at least one droplet of the mixed ink 7c. If several droplets of the first printing ink 7a and/or second printing ink 7b are required according to the determined mixing ratio, the droplets are ejectable with different speeds, thus ensuring that the droplets mix in-flight, i.e. after being ejected and before being deposited. The at least one resulting droplet of mixed ink 7c is then deposited on the substrate 3 and/or at least partially above another droplet of mixed ink 7c. The droplet of mixed ink 7c is cured by the curing devices 6, 6′ and the optical structure is built up by repeating the described steps sequentially.

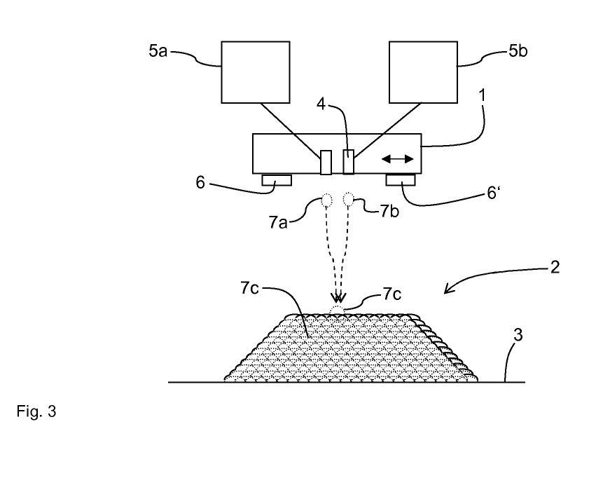

In FIG. 3, a method for printing a three-dimensional optical structure 2 having a specific refractive index nₒ and a print head 1 according to a third exemplary embodiment of the present invention are shown schematically. The third exemplary embodiment corresponds substantially to the second exemplary embodiment, with the difference that according to the third exemplary embodiment, the mixing of the first printing ink 7a and the second printing ink 7b is performed after depositing. This means that after determining the required mixing ratio, at least one droplet of the first printing ink 7a is ejected and deposited at a certain position of the substrate 3, and subsequently at least one droplet of the second printing ink 7b is ejected at substantially the same position of the substrate 3. The at least one droplet of the first printing ink 7a and the at least one droplet of the second printing ink 7b mix and yield at least one droplet of the mixed ink 7c. Only after the at least one droplet of mixed ink 7c is created, the curing devices 6, 6′ cure the structure totally. This means that a certain degree of curing can already occur at an earlier stage of the process. According to a further embodiment, the print head 1 comprises only one ejection device 4, wherein the ejection device 4 is configured for ejecting at least one droplet of the first printing ink 7a and at least one droplet of the second printing ink 7b. By subsequently depositing both printing inks 7a, 7b, the print head 1 can operate with only one ejection device 4 and still provide a mixed ink 7c having a refractive index n_{c} equal to the desired specific refractive index nₒ.

### REFERENCE SIGNS

1—print head
2—optical structure
3—substrate
4—ejection device
5—ink tank
5a—first ink tank
5b—second ink tank
5c—mixing chamber/mixed ink tank
6, 6′—curing device
7—printing ink
7a—first printing ink
7b—second printing ink
7c—mixed ink
nₒ—specific refractive index (of the optical structure)
nₐ—first refractive index
n_{b}—second refractive index
n_{c}—refractive index of the mixed ink

What is claimed is:

1. Print head printing an optical structure having a specific refractive index (nₒ) on a substrate, the print head comprising at least one ejection device, a first ink tank, a second ink tank and a curing device, wherein the ejection device is configured for ejecting at least one droplet of at least one printing ink towards the substrate, wherein the first ink tank comprises a first printing ink, wherein the second ink tank comprises a second printing ink, wherein the first printing ink has a first refractive index (nₐ) being different from the specific refractive index (nₒ), wherein the second printing ink has a second refractive index (n_{b}) being different from the specific refractive index (nₒ) and being different from the first refractive index (nₐ), wherein the print head is configured such that the first printing ink and the second printing ink are mixed in such a ratio yielding a mixed ink having a refractive index (n_{c}) equal to the desired specific refractive index (nₒ).

2. Print head according to claim 1, characterized in that the print head comprises separate ejection devices for each printing ink and that each ejection device is connected at least to an ink tank comprising the corresponding printing ink.

3. Print head according to claim 1, characterized in that the print head is configured such that at least one droplet of the first printing ink and at least one droplet of the second printing ink are mixed in flight after being ejected and before being deposited on the substrate.

4. Print head according to claim 1, characterized in that the print head is configured such that at least one droplet of the first printing ink and at least one droplet of the second printing ink are mixed in a mixing chamber of the print head before being ejected.

5. Print head according to claim 1, characterized in that the print head is configured such that at least one droplet of the first printing ink is deposited on the substrate and at least one droplet of the second printing ink is deposited substantially at the same position of the substrate before being totally cured, yielding a droplet of mixed ink.

6. Print head according to claim 1, characterized in that the curing device is configured for curing at least one droplet of the mixed ink that is deposited on the substrate, wherein the curing device comprises an ultraviolet light emitting diode.

7. Print head according to claim 1, characterized in that the size of a droplet of the first printing ink and/or second printing ink and/or mixed ink is different from the size of another droplet of the first printing ink and/or second printing ink and/or mixed ink.

8. Print head according to claim 1, characterized in that the first printing ink and/or second minting ink is substantially transparent, wherein the print head is further configured for ejecting at least one droplet of third printing ink, wherein the print head comprises at least a third ink tank, wherein the third ink tank comprises the third printing ink, wherein the third printing ink is a colored printing ink and wherein the mixed ink comprises at least one droplet of the third printing ink.

9. Method for printing an optical structure having a specific refractive index (nₒ) on a substrate, using a print head ejecting at least one droplet of at least one printing ink, according to claim 1, comprising the steps of
determining the required mixing ratio of at least a first printing ink having a first refractive index (nₐ) and at least a second printing ink having a second refractive index (n_{b}) such that the resulting mixed ink has a refractive index (n_{c}) that equals the desired specific refractive index (nₒ), wherein the first refractive index (nₐ) differs from the specific refractive index (nₒ) and wherein the second refractive index (n_{b}) differs from the specific refractive index (nₒ) and from the first refractive index (nₐ),
mixing the first printing, ink and the second printing ink according to the determined ratio,
curing at least one droplet of the mixed ink that is deposited on the substrate.

10. Method according to claim 9, characterized in that the method includes the steps of ejecting at least one droplet of the first printing ink and at least one droplet of the second printing ink, and/or ejecting at least one droplet of the mixed ink, and/or the curing of the deposited droplets is performed by an ultraviolet light source having an ultraviolet light emitting diode.

11. Method according to claim 9, characterized in that multiple droplets of the first printing ink and/or second printing ink and/or the mixed ink are deposited at least partially on top of each other and/or side by side.

12. Method according to claim 9, characterized in that at least one droplet of the first printing ink and at least one droplet of the second printing ink are mixed in-flight after being ejected and before being deposited.

13. Method according to claim 9, characterized in that at least one droplet of the first printing ink and at least one droplet of the second printing ink are mixed in a mixing chamber of the print head before being ejected.

14. Method according to claim 9, characterized in that at least one droplet of the first printing ink is deposited on the substrate and at least one droplet of the second printing, ink is deposited substantially at the same position of the substrate, before being totally cured, yielding a droplet of mixed ink.

15. Method according to claim 9, characterized in that the droplets of the first printing ink and/or second printing ink and/or mixed ink are ejected in different sizes.

16. Method according to claim 9, characterized in that the droplets of the first printing ink and/or second printing ink and/or mixed ink are ejected in different sizes.

17. Method according to claim 9, characterized in that the steps are performed for producing a three dimensional optical structure having at least two different pans, each having a different specific refractive index.

18. Method according to claim 12, characterized in that the steps are performed for producing a three dimensional optical structure having at least two different parts, each having a different specific refractive index.

19. Print head according to claim 3, characterized in that the curing device is configured for curing at least one droplet of the mixed ink that is deposited on the substrate, wherein the curing device comprises an ultraviolet light emitting diode.

20. Print head according to claim 5, characterized in that the size of a droplet of the first printing ink and/or second printing ink and/or mixed ink is different from the size of another droplet of the first printing ink and/or second printing ink and/or mixed ink.
